(19) United States
(12) Patent Application Publication
(10) Pub. No.: US 2009/0152965 A1
(43) Pub. Date: Jun. 18, 2009

(54) Winding Assembly for Motor

(76) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/016,339

(22) Filed: Jan. 18, 2008

(30) Foreign Application Priority Data
Dec. 18, 2007 (TW) 096148442

(51) Int. Cl. H01F 27/30; H02K 3/50

(52) U.S. Cl. 310/71; 336/90; 310/179

(57) ABSTRACT

A winding assembly for a motor includes a base having a supporting face. A winding includes two ends and a plane that is in intimate contact with the support face of the base. A packaging body encloses the base and the winding. Two electrical connection members are respectively connected with the ends of the winding. Each electrical connection member is partially exposed outside the packaging body.

### BACKGROUND OF THE INVENTION

1. Field of the Invention

The present invention relates to a winding assembly for a motor and, more particularly, to a winding assembly including a winding, a base for supporting the winding, and a packaging body for packaging the winding and the base.

2. Description of Related Art

A typical motor generally includes a plurality of windings and a magnet unit. The windings are energized by current to create a magnetic field for magnetic induction with another magnetic field created by a magnetic member such as a magnet for driving a rotor to rotate. FIG. 1 illustrates a conventional winding 9 formed by winding a conductive wire in a clockwise or counterclockwise direction to have a desired number of turns. Two ends of the conductive wire are utilized as electric connections 91 and 92 for electrical connection with other windings or peripheral circuits.

However, the conductive wire has a relatively small diameter such that the connections 91 and 92 are liable to break off during soldering for electrically connecting the connections 91 and 92 with other windings or peripheral circuits, leading to an increase in the costs, for the whole winding 9 must be replaced with a new one. Furthermore, in a case of connecting several windings 9, the polarity of each connection 91, 92 of each winding 9 must be noted to provide a magnetic field with a predetermined direction when a current flows through the windings 9, which is a difficult task. As a result, desoldering and resoldering procedures are required while an error is occurred in polarity noting, which lead to complicated processing. Furthermore, the winding 9 is exposed during assembly of a motor such that the insulation varnish of the winding 9 is liable to wear out by the processing tools and, thus, causes short-circuit of the winding 9. Therefore the defective rate of the windings 9 is increased.

### SUMMARY OF THE INVENTION

An object of the present invention is to provide a winding assembly for a motor to allow convenient assembly of motors and to increase the yield rate of motors.

A winding assembly for a motor according to the preferred teachings of the present invention includes a base including a supporting face. A winding includes two ends and a plane that is in intimate contact with the support face of the base. A packaging body encloses the base and the winding. Two electrical connection members are respectively connected with the ends of the winding. Each electrical connection member is partially exposed outside the packaging body.

Preferably, each electrical connection member includes an inner connecting portion in the packaging body and electrically connected to one of the ends of the winding. Each electrical connection member further includes an outer connecting portion outside the packaging body.

An assembling direction of the outer connecting portions of the electrical connection members can be perpendicular or parallel to the supporting face of the base.

In a preferred embodiment, the winding assembly further includes an assembling hole extending through the winding, the base, and the packaging body and perpendicular to the support face of the base.

Other objects, advantages and novel features of this invention will become more apparent from the following detailed description when taken in conjunction with the accompanying drawings.

### BRIEF DESCRIPTION OF THE DRAWINGS

FIG. 1 shows a perspective view of a conventional winding for a motor.

FIG. 2 shows a perspective view of a winding assembly of a first embodiment according to the preferred teachings of the present invention.

FIG. 3 shows a cross-sectional view of the winding assembly of FIG. 2.

FIG. 4 shows an exploded perspective view of an axial gap type motor utilizing the winding assembly of FIG. 2.

FIG. 5 shows a perspective view of a winding assembly for a motor of a second embodiment according to the preferred teachings of the present invention.

FIG. 6 shows an exploded view of a radial gap type motor utilizing four winding assemblies of FIG. 5.

FIG. 7 shows a perspective view of a winding assembly for a motor of a third embodiment according to the preferred teachings of the present invention.

FIG. 8 shows an exploded view of an axial gap type motor utilizing the winding assembly of FIG. 7.

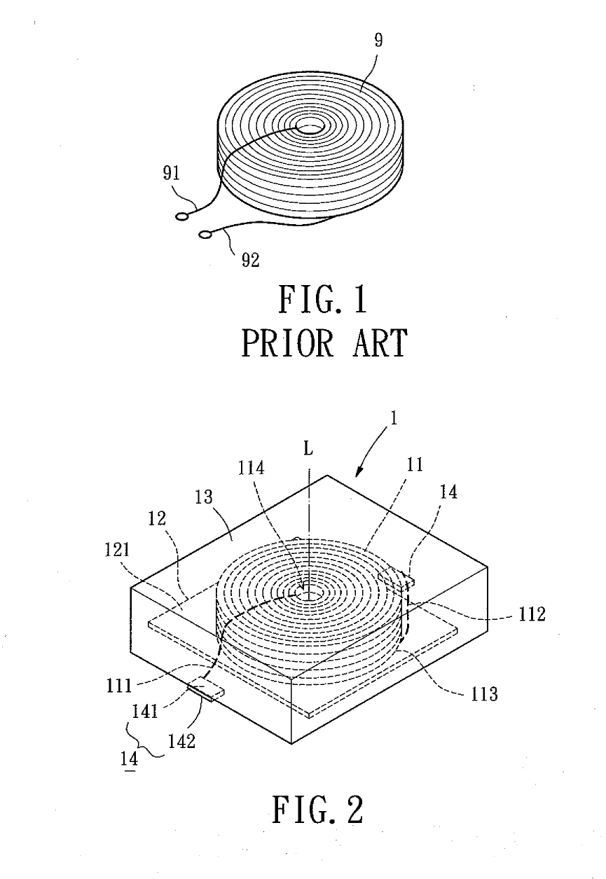

### DETAILED DESCRIPTION OF THE PREFERRED EMBODIMENTS

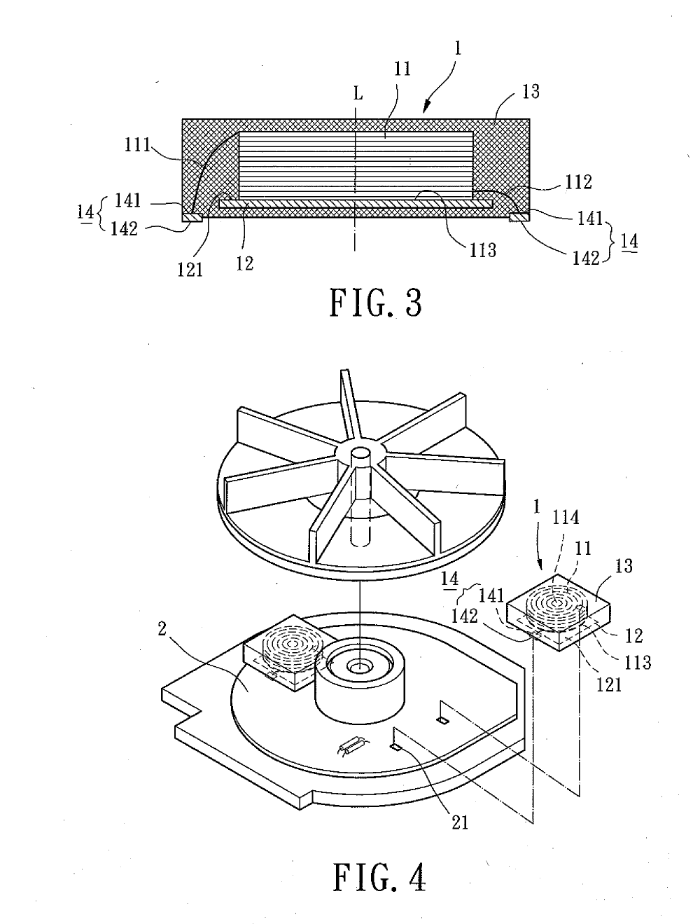

A winding assembly I for a motor of a first embodiment according to the preferred teachings of the present invention is shown in FIGS. 2 and 3. The winding assembly 1 includes a winding 11, a base 12, a packaging body 13, and a pair of electrical connection members 14. The winding 11 is formed by winding a conductive wire about an axis L and includes two ends 111 and 112, a plane 113 perpendicular to the axis L, and a central hole 114 extending throughout the winding 111 and perpendicular to the plane 113. The winding direction of the winding 11 can be clockwise or counterclockwise according to the direction of the magnetic field (i.e., the outflow and inflow directions of the sole and north poles) to be created.

Still referring to FIGS. 2 and 3, the base 12 of the winding assembly I of the first embodiment according to the preferred teachings of the present invention can be a non-metal plate or a metal plate and includes a supporting face 121 in intimate contact with the plane 113 of the winding 11. The packaging body 13 encloses the winding 11 and the base 12. The packaging body 13 is made of a non-magnetically conductive, non-electrically conductive material such as a packaging gel made of epoxy resin. The supporting face 121 is parallel to the plane 113 and perpendicular to the axis L. By such an arrangement, the positioning effect and the supporting effect of the winding 11 and the base 12 packaged in the packaging body 13 are enhanced.

As can be seen from FIGS. 2 and 3, the winding 11 and the base 12 are enclosed in the packaging body 3 and, thus, not exposed, avoiding damage to the insulation varnish covering the winding 11 and, thus, avoiding short-circuit of the winding 11. Furthermore, the winding 11 is isolated from ambient air, avoiding aging of the winding 11 resulting from oxidization and assuring reliable electrical connection.

Still referring to FIGS. 2 and 3, the electrical connection members 14 of the winding assembly 1 of the first embodiment according to the preferred teachings of the present invention are made of an electrically conductive material such as copper or silver. The electrical connection members 14 are respectively connected to the ends 111 and 112 of the winding 11 and partially exposed outside the packaging body 13. Specifically, as can be seen from FIG. 3, each electrical connection member 14 includes an inner connecting portion 141 in the packaging body 13 and connected to one of the ends 111 and 112 of the winding 11. Each electrical connection member 14 further includes an outer connecting portion 142 disposed at a face of the packaging body 13 for electrical connection with peripheral circuits, with the face preferably being parallel to the base 12 as shown in FIG. 3. Current can be feed to the winding through the outer connecting portions 142 of the electrical connection members 14 to energize the winding 11 for creating a magnetic field. A test can be carried out on the winding assembly 1 to find out the positive and negative poles of the winding assembly 1. Marks indicating the positive and negative poles of the winding assembly I can be provided adjacent the outer connecting portions 142 for easy identification by a worker when proceeding with electrical connection with the peripheral circuits.

FIG. 4 shows an exploded perspective view of an axial gap type motor utilizing the winding assembly 1 of FIG. 2. The outer connecting portions 142 of the electrical connection members 14 of the winding assembly 1 are connected with two electrical connections 21 of a driving circuit board 2 for energizing the winding 11 to create an axial magnetic field. In this case, the face of the packing body 13, at which the outer connecting portion 142 is disposed, faces the driving circuit board 2, with the face preferably abutting the driving circuit board 2. However, said face can also be perpendicular to the driving circuit board 2 with the outer connecting portion 142 extending to the driving circuit board 2.

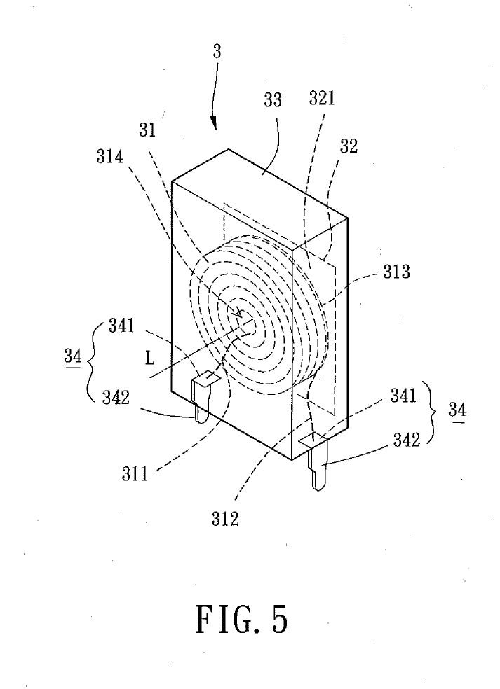

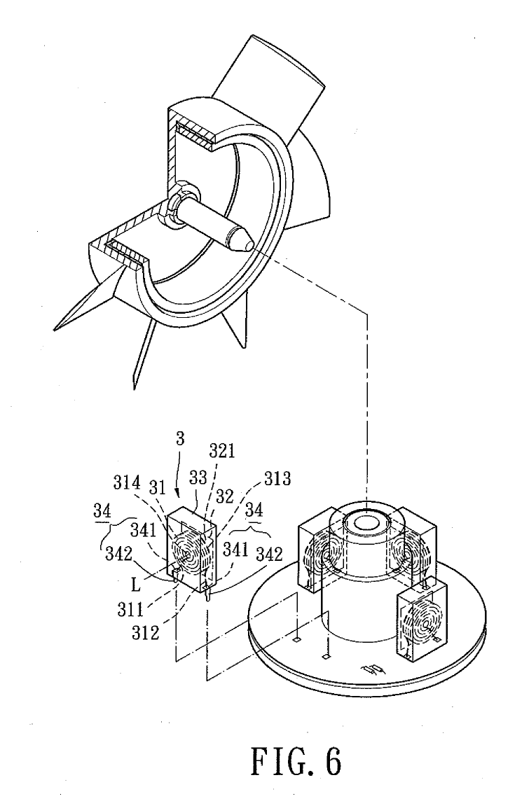

FIG. 5 shows a perspective view of a winding assembly 3 for a motor of a second embodiment according to the preferred teachings of the present invention. FIG. 6 shows an exploded view of a radial gap type motor utilizing four winding assemblies 3 of FIG. 5. The winding assembly 3 also includes a winding 31, a base 32, a packaging body 33, and a pair of electrical connection members 34. The winding 31 also includes two ends 311 and 312, a plane 313, and a central hole 314. The base 32 also includes a supporting face 321 for intimate contact with the plane 313. The difference between the winding assembly 3 of the second embodiment and the winding assembly 1 of the first embodiment is that a face of the packing body 33, at which an outer connecting portion 342 is disposed, is perpendicular to the base 32. Thus, the winding assembly 3 of the second embodiment can be utilized on a radial gap type motor, allowing wider application of the motor assembly according to the preferred teachings of the present invention.

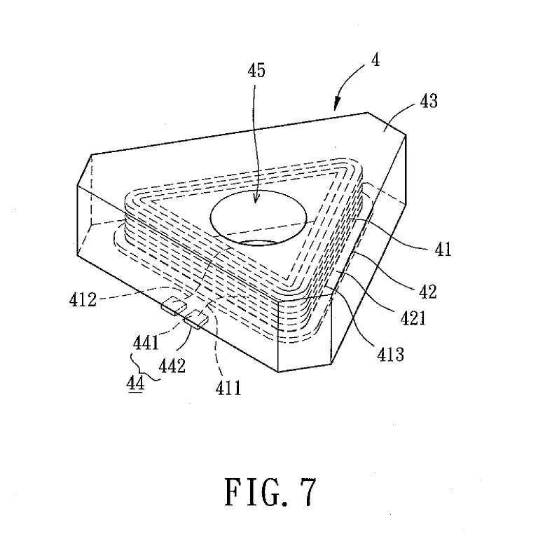

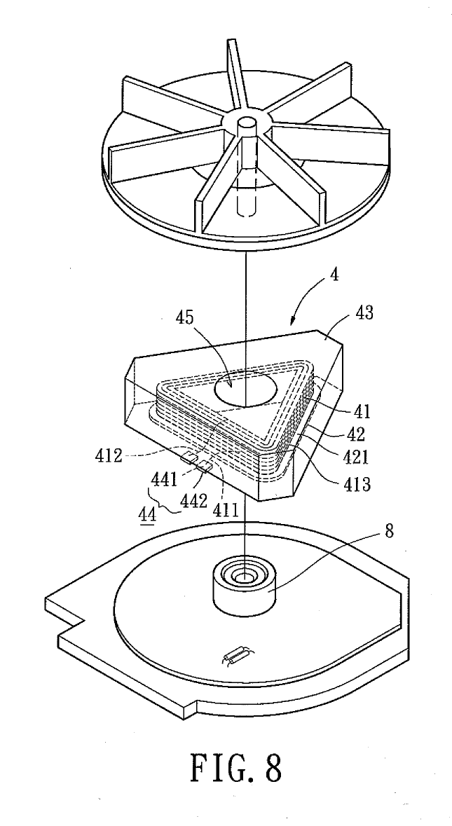

FIG. 7 shows a perspective view of a winding assembly 4 for a motor of a third embodiment according to the preferred teachings of the present invention. FIG. 8 shows an exploded view of an axial gap type motor utilizing the winding assembly 4 of FIG. 7. The winding assembly 4 also includes a winding 41, a base 42, a packaging body 43, and a pair of electrical connection members 44. The winding 41 also includes two ends 411 and 412, and a plane 413. The base 42 also includes a supporting face 421 for intimate contact with the plane 413. The winding assembly 4 of the third embodiment is substantially the same as the winding assembly 1 of the first embodiment. The differences between the winding assembly 4 of the third embodiment and the winding assembly 1 of the first embodiment are that the winding 41 has triangular cross-sections and that the winding assembly 4 includes an assembling hole 45 allowing the winding assembly 4 to be easily mounted around an axle tube 8 (FIG. 8) of a motor. The assembling hole 45 preferably extends throughout a center of the winding assembly 4. Specifically, the assembling hole 45 extends through the packaging body 43, the winding 41, and the base 42.

It can be appreciated that the winding assemblies 1, 3, and 4 according to the preferred teachings of the present invention provides assembling convenience and increases the yield rate of motors by packaging the winding 11, 31, 41 and the base 12, 32, 42 in a packaging body 13, 33, 43 while leaving exposed outer connecting portions 142, 342, and 442 for easy electrical connection and by providing readily perceivable marks indicating the positive and negative poles of the winding assemblies 1, 3, and 4.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A winding assembly for a motor comprising:
a base including a supporting face;
a winding including two ends and a plane, with the plane being in intimate contact with the support face of the base;
a packaging body enclosing the base and the winding; and
two electrical connection members respectively connected with the two ends of the winding, with each of the electrical connection members being partially exposed outside the packaging body.

2. The winding assembly for a motor as claimed in claim 1, with each of the two electrical connection members including an inner connecting portion in the packaging body and electrically connected to one of the two ends of the winding, and with each of the two electrical connection members further including an outer connecting portion disposed at a face of the packaging body.

3. The winding assembly for a motor as claimed in claim 2, with the face, at which the outer connecting portion is disposed, being perpendicular or parallel to the base.

4. The winding assembly for a motor as claimed in claim 3, with said face abutting a driving circuit board when the face is parallel to the base and the winding assembly electrically connects to said driving circuit board.

5. The winding assembly for a motor as claimed in claim 1, with the winding further comprising a central hole extending therethrough and perpendicular to the plane of the winding.

6. A winding assembly for a motor comprising:
a base including a supporting face;
a winding including two ends and a plane, with the plane being in intimate contact with the support face of the base;
a packaging body enclosing the base and the winding;
two electrical connection members respectively connected with the two ends of the winding, with each of the electrical connection members being partially exposed outside the packaging body; and
an assembling hole extending through the winding, the base, and the packaging body and perpendicular to the support face of the base.

7. The winding assembly for a motor as claimed in claim 6, with the assembling hole being in a center of the winding assembly.

8. The winding assembly for a motor as claimed in claim 6, with the winding assembly having triangular cross-sections.

9. The winding assembly for a motor as claimed in claim 6, with each of the two electrical connection members including an inner connecting portion in the packaging body and electrically connected to one of the two ends of the winding, and with each of the two electrical connection members including an outer connecting portion disposed at a face of the packaging body.

10. The winding assembly for a motor as claimed in claim 6, with the face, at which the outer connecting portion is disposed, being perpendicular or parallel to the base.
